(19) United States
(12) Patent Application Publication
(10) Pub. No.: US 2025/0218196 A1
(43) Pub. Date: Jul. 3, 2025

(54) Method and Device for Detecting Indication Signs, Controller, Vehicle, and Medium

(71) Applicant: Robert Bosch GmbH, Stuttgart (DE)

(72) Inventor: Chen Yang, Suzhou (CN)

(21) Appl. No.: 19/003,242

(22) Filed: Dec. 27, 2024

(30) Foreign Application Priority Data
Dec. 29, 2023 (CN) 2023 1187 1123.8

(51) Int. Cl. G06V 20/58; G06V 10/82

(52) U.S. Cl. CPC G06V 20/582; G06V 10/82

(57) ABSTRACT

A method and a device for detecting indication signs, a controller, a vehicle, and a medium is disclosed. The method includes (i) acquiring an image including indication signs, wherein constituent elements of the indication signs include at least one of an arrow element and a line segment element, (ii) determining, based on the image, locations and categories of critical points of the constituent elements, wherein the locations of the critical points are used for identifying areas of the indication signs, and (iii) determining semantics of the indication signs based on the categories of the critical points. By this mode, location and classification information of the critical points can be acquired from the image, thereby increasing the richness of the information of the critical points, and characterizing the indication signs in the image through the critical points to avoid inaccurate and incomplete results caused by direct classification of the entire indication signs. By way of the above, the accuracy of detection of the indication signs may be improved.

This application claims priority under 35 U.S.C. § 119 to patent application no. CN 2023 1187 1123.8, filed on Dec. 29, 2023 in China, the disclosure of which is incorporated herein by reference in its entirety.

Embodiments of the present disclosure relate generally to the field of smart driving, in particular to a method and a device for detecting indication signs, a controller, a vehicle, and a medium.

### BACKGROUND

Indication signs are important traffic signs for guiding vehicles and are widely used in roads, parking lots and other scenarios. For example, the indication signs may predict road conditions and indicate driving directions, driving distances and other information for vehicles, thereby regulating traffic behaviors of various vehicle scenarios. Indication signs are generally composed of arrow graphics, and a small number of indication signs will also involve other graphics such as line segment graphics.

With the development of the autonomous driving technology, whether it is an autonomous driving system or an advanced driving assistance system (abbreviated as ADAS), its planning and control algorithms require to acquire road environment information such as marking lines on the roads through vehicle-mounted cameras to control driving processes of the vehicles. The more sophisticated the road environment information acquired by a planning and control algorithm module is, the closer the decision made is to the person or to the traffic regulations.

### SUMMARY

Embodiments of the present disclosure provide a method and a device for detecting indication signs, a controller, a vehicle, and a medium. In examples of the present disclosure, the image collected by a sensing apparatus such as a vehicle-mounted camera and containing indication signs is acquired first, wherein the indication signs may include at least one arrow element, may also include at least one line segment element, or may also include a combination of at least one arrow element and at least one line segment element. The image is then detected, thereby determining a location and a category of a critical point of each constituent element in the indication signs. Further, when the locations of the critical points satisfy a location condition, based on the category of the critical point of each constituent element in the indication signs, semantics of the indication signs are determined (e.g., the semantics of the indication signs may be composition information of the category of the critical point of each constituent element).

By this mode, location and classification information of the critical points can be acquired from the image, thereby increasing the richness of the information of the critical points, and characterizing the indication signs in the image through the critical points to avoid inaccurate and incomplete results caused by direct classification of the entire indication signs. As a result, the mode of the present disclosure may improve the accuracy of detection of the indication signs.

In a first aspect of the present disclosure, a method for detecting indication signs is provided. The method includes acquiring an image including the indication signs, constituent elements of the indication signs including at least one of an arrow element and a line segment element. The method further comprises determining, based on the image, locations and categories of critical points of the constituent elements. In addition, the method further comprises determining, based on the categories of the critical points, semantics of the indication signs in response to the locations of the critical points satisfying the location condition.

In a second aspect of the present disclosure, a device for detecting indication signs is provided. The device includes an image acquisition module configured to acquire an image including indication signs, constituent elements of the indication signs including at least one of an arrow element and a line segment element. The device further includes a critical point determination module configured to determine, based on the image, locations and categories of critical points of the constituent elements; and in addition, the device further includes an indication sign determination module configured to determine, based on the categories of the critical points, semantics of the indication signs in response to the locations of the critical points satisfying the location condition.

In a third aspect of the present disclosure, a controller is provided. The controller comprises one or more processors; and a storage device for storing one or more programs, the one or more programs, when executed by the one or more processors, causing the one or more processors to implement a method provided according to the first aspect of the present disclosure.

According to a fourth aspect of the present disclosure, a vehicle is provided. The vehicle includes a controller provided according to the third aspect of the present disclosure.

In a fifth aspect of the present disclosure, a machine-readable storage medium is provided. The machine-readable storage medium has machine-executable instructions stored thereon, wherein the machine-executable instructions are executed by a processor to implement the method provided according to the first aspect of the present disclosure.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various examples of the present disclosure will become more apparent in combination with the accompanying drawings and with reference to the following detailed description. In the accompanying drawings, like or similar accompanying drawings designate like or similar elements, wherein:

FIG. 1 shows a schematic diagram of an example environment in which some examples of the present disclosure may be implemented;

FIG. 2 shows a flow chart of a method for detecting indication signs according to some examples of the present disclosure;

FIG. 3A shows a schematic view of an indication sign including a bottom left corner point according to some examples of the present disclosure;

FIG. 3B shows a schematic view of an indication sign including a bottom right corner point according to some examples of the present disclosure;

FIG. 3C shows a schematic view of an indication sign including a vertex according to some examples of the present disclosure;

FIG. 3D shows a schematic diagram of an indication sign including an inflection point according to some examples of the present disclosure;

FIG. 3E shows a schematic view of an indication sign including a vertex and corner points according to some examples of the present disclosure;

FIG. 3F shows a schematic diagram of an indication sign including an endpoint according to some examples of the present disclosure;

FIG. 3G shows a schematic view of an indication sign including a plurality of critical points according to some examples of the present disclosure;

FIG. 4 shows a schematic diagram of a process for detecting critical points of indication signs according to some examples of the present disclosure;

FIG. 5 shows a block diagram of a device for detecting indication signs according to some examples of the present disclosure; and

FIG. 6 shows a schematic block diagram of an example apparatus according to some examples of the present disclosure.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to and represent different or the same object. Other explicit and implicit definitions may be included below.

For an autonomous driving systems or an advanced driving assistance system, in order to ensure the accuracy and timeliness in the driving process, the implementation of its planning and control algorithms requires accurate and efficient indication sign acquisition modes. Traditionally, locations of constituent elements in the indication signs are acquired by an image detection mode. However, the locations of the constituent elements are generally identified by a mode of boundary frames in a conventional mode, which requires more parameters when there is a greater number of constituent elements, and which can easily result in information redundancy. Moreover, semantics of arrow elements cannot be acquired in the conventional mode, resulting in inaccurate and incomplete test results.

To this end, examples of the present disclosure provide a method for detecting indication signs, and an image collected by a sensing apparatus such as a vehicle-mounted camera and containing indication signs is acquired first, wherein the indication signs may include at least one arrow element, may also include at least one line segment element, or may also include a combination of at least one arrow element and at least one line segment element. The image is then detected, thereby determining a location and a category of a critical point of each constituent element in the indication signs. Further, when the locations of the critical points satisfy a location condition, based on the category of the critical point of each constituent element in the indication signs, semantics of the indication signs are determined (e.g., the semantics of the indication signs may be composition information of the category of the critical point of each constituent element).

By this mode, a location and a category of each critical point of the constituent elements in the indication signs may be calculated directly based on the image. The locations of the critical points can be directly used for identifying areas of the indication signs (the locations of the critical points can be used for identifying areas of the corresponding constituent elements, when the number of the constituent elements is one, the areas of the indication signs can be directly identified based on the locations of the critical points, and when the number of the constituent elements is multiple, the areas of the indication signs can be identified based on a combination of the locations of the critical points), through the locations of the critical points, the areas of the indication signs can be quickly determined, and information redundancy (particularly when the number of constituent elements in the indication signs is large, boundary frames will overlap a lot) caused when the indication signs are identified by a mode of boundary frames and the like can be avoided; and meanwhile, the quantity of parameters in the process of determining the areas of the indication signs can be reduced. The categories of the critical points, as association information of the critical points, can increase the richness of information of the critical points, thereby directly determining the semantics of the indication signs based on the categories of the critical points, and avoiding the inaccurate and incomplete results caused by directly classifying the entire indication signs. As a result, the mode of the present disclosure can improve the accuracy and speed of detection of the indication signs and reduce redundant information.

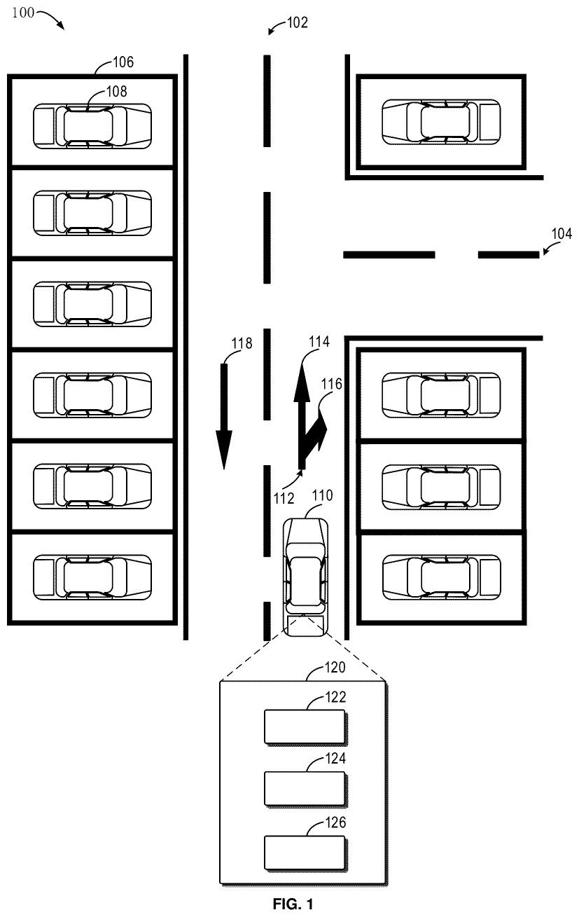

FIG. 1 shows a schematic diagram of an example environment 100 in which some examples of the present disclosure may be implemented. Referring to FIG. 1, the example environment 100 is a local parking scenario in a parking lot. The example environment 100 includes a straight lane 102 and a cross lane 104, the straight lane 102 and the cross lane 104 both being left and right dual-lanes. On both sides of the straight lane 102 and the cross lane 104, there are a plurality of parking spaces arranged in sequence, such as a parking space 106, and there are a plurality of parking vehicles, such as a parking vehicle 108 in the plurality of parking spaces. A self-vehicle 110 travels on a right lane in the straight lane 102.

With continued reference to FIG. 1, there are indication signs 112 on the ground in front of the self-vehicle 110, the indication signs include a straight arrow 114 (which may be referred to as an arrow element) and a right turn arrow 116 (which may be referred to as an arrow element). Therefore, there are two constituent elements being present in the indication signs 112. There are also indication signs 118 in a left lane of the straight lane 102, and only one straight arrow is present in the indication signs 118. Therefore, there is only one constituent element being present in the indication signs 118.

With continued reference to FIG. 1, an electronic device 120 is provided in the self-vehicle 110, and the electronic device 120 may be implemented by a micro controller unit (hereinafter referred to as MCU), a central processing unit (hereinafter referred to as CPU), a graphical processing unit (hereinafter referred to as GPU), a field programmable logic gate array (hereinafter referred to as FPGA), or other programmable logic devices, application-specific integrated circuits, discrete gate or transistor logic device, discrete hardware components, etc. The electronic device 120 includes an image acquisition unit 122, a critical point determination unit 124, and an indication sign determination unit 126.

The image acquisition unit 122 is used for receiving an image including indication signs 112 from a visual sensor, such as a vehicle-mounted camera, wherein the constituent elements of the indication signs 112 include a straight arrow 114 and a right turn arrow 116. The critical point determination unit 124 is used for analyzing the image, thereby obtaining locations and categories of the critical points of the straight arrow 114 and the right turn arrow 116 in the indication signs 112. The locations of the critical points may be used for identifying the locations of the straight arrow 114 or the right turn arrow 116, the categories of the critical points are semantic information of the critical points, and the categories of the critical points are generally associated with the corresponding straight arrow 114 or right turn arrow 116. The indication sign determination unit 126 is used for determining semantics of the indication signs 116 according to the categories of the critical points, for example, the semantics of the indication signs 116 may be a combination of the categories of the critical points.

By this mode, the location and the category of each critical point of the constituent elements in the indication signs 112 (the straight arrow 114 and the right turn arrow 116) may be calculated directly based on the collected image. The locations of the critical points can be directly used for identifying areas of the indication signs 114 (the locations of the critical points can be used for identifying areas of the corresponding constituent elements, and the areas of the indication signs 112 can be identified based on a combination of the locations of the critical points), through the locations of the critical points, the areas of the indication signs 112 can be quickly determined, and information redundancy (particularly when the number of constituent elements in the indication signs 112 is large, the boundary frames will overlap a lot) caused when the indication signs 112 are identified by a mode of the boundary frames and the like can be avoided; and meanwhile, the quantity of parameters in the process of determining the areas of the indication signs 112 can be reduced. The categories of the critical points, as semantic information of the critical points, can increase the richness of information of the critical points, thereby directly determining the semantics of the indication signs 112 based on the categories of the critical points, and avoiding the inaccurate and incomplete results caused by directly classifying the entire indication signs 112. As a result, the mode of the present disclosure can improve the accuracy and speed of detection of the indication signs 112 and reduce redundant information.

It will be understood that the architecture and functions in the example environment 100 are described for exemplary purposes only, without implying any limitation to the scope of the present disclosure. Embodiments of the present disclosure may also be applied to other environments having different structures and/or functions.

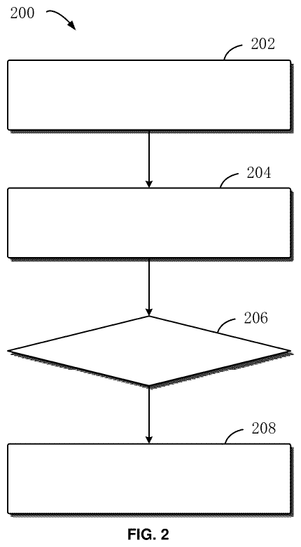

The process according to examples of the present disclosure will be described in detail below in conjunction with FIG. 2 to FIG. 6. For ease of understanding, the specific data mentioned in the following description are exemplary and are not used for defining the scope of protection of the present disclosure. It will be understood that the examples described below may also include additional actions not shown and/or actions that may be omitted as shown, the scope of the present disclosure being not limited in this regard.

FIG. 2 shows a flow chart of a method 200 for detecting indication signs according to some examples of the present disclosure. In some examples, in the example environment 100 shown in FIG. 1, the method 200 may be performed by the electronic device 120. It will be understood that the method 200 may also include additional actions not shown and/or actions that may be omitted as shown, the scope of the present disclosure being not limited in this regard.

At step 202, the electronic device 120 acquires an image including indication signs, constituent elements of the indication signs including at least one of an arrow element and a line segment element. In some examples, a plurality of constituent elements are present in the indication signs, each constituent element corresponding to one type of vehicle instruction information. The constituent elements may be classified into arrow elements and line segment elements by categories, and the indication signs may consist of at least one arrow element, may also consist of at least one line segment element, and may also consist of at least one arrow element and at least one line segment element at the same time. For example, in the indication signs 112, its constituent elements include a straight arrow 114 and a right turn arrow 116 (both of which are arrow elements), the straight arrow 114 corresponding to information directing the vehicle to go straight, and the right turn arrow 116 corresponding to information directing the vehicle to turn right.

In some examples, the camera of the self-vehicle 110 directly collects visual sensing signals in front of the vehicle or in other orientations and sends the visual sensing signals to the electronic device 120, and the electronic device 120 receives the visual sensing signals and generates an image. Alternatively or additionally, the camera (e.g., a smart camera) of the self-vehicle 110 collects visual sensing signals in front of the vehicle or in other orientations, then generates an image based on the visual sensing signals and sends the generated image to the electronic device 120, and the electronic device 120 receives the image.

At step 204, the electronic device 120 determines, based on the image, the locations and the categories of the critical points of the constituent elements, the locations of the critical points being used for identifying the areas of the indication signs. In some examples, the electronic device 120 analyzes the image, thereby obtaining the locations and the categories of the critical points of the constituent elements in the indication signs. The critical points of the constituent elements are points that have an identification effect on the constituent elements, such as the vertex of the straight arrow 114.

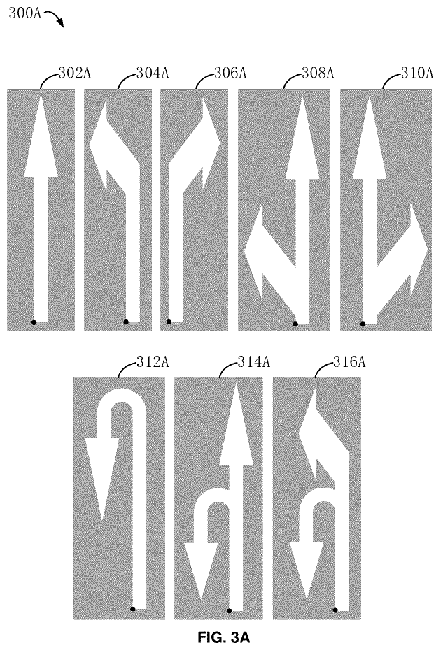

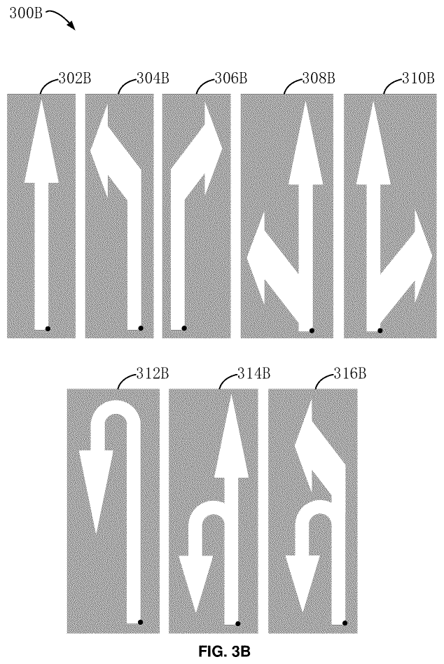

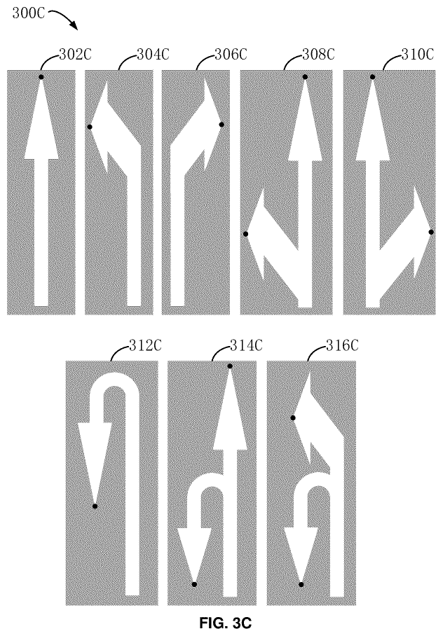

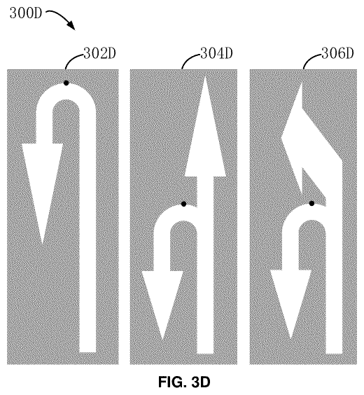

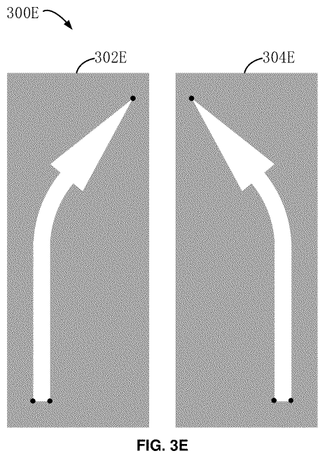

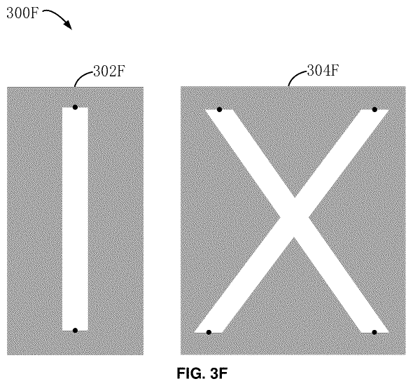

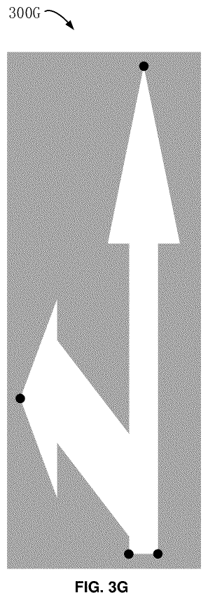

In some examples, the locations of the critical points may be used for identifying the areas of the corresponding constituent elements. As a result, when the number of the constituent elements is one, the areas of the indication signs may be directly identified based on the locations of the critical points; and when the number of the constituent elements is multiple, the areas of the indication signs may be identified based on a combination of the locations of the critical points. The categories of the critical points, as the semantic information of the critical points, can be used for identifying the categories of the corresponding constituent elements. For example, the semantic corresponding to the vertex of the straight arrow 114 may be the “vertex of the straight arrow.” The locations and the categories of the critical points will be illustrated below in conjunction with FIG. 3A to FIG. 3G.

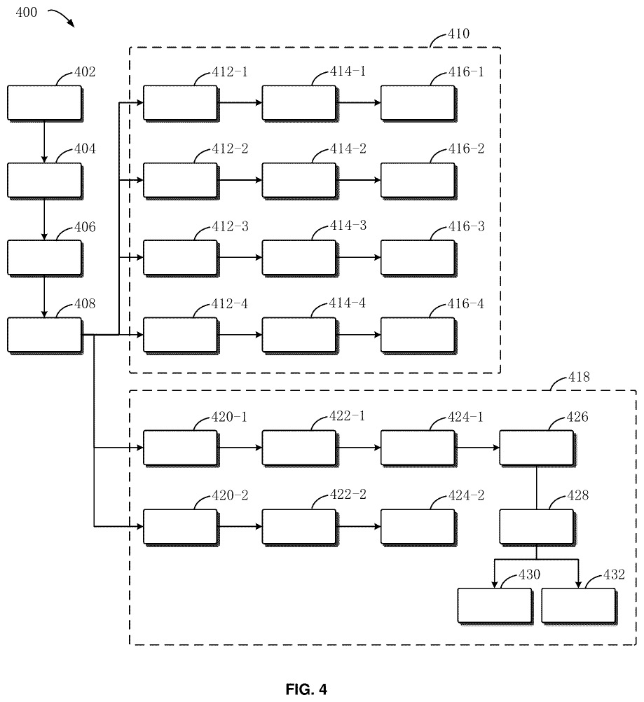

In some examples, the image may be detected by a neural network model, thereby determining the locations and the categories of the critical points of the constituent elements in the indication signs. Compared with conventional image processing solutions such as the mode of designing manual features, by this mode, the limitation of detection of objects corresponding to the manual features only can be avoided, and the impact of interference items of other marks on the road on the test results can be avoided, thereby improving the accuracy of detection of the indication signs. The process of detecting the critical points based on the neural network model will be illustrated below in connection with FIG. 4.

In some examples, the categories of the critical points include visible points and invisible points, wherein the visible points include directly observable points such as the vertex of the straight arrow and corner points of the left turn arrow, etc., and the invisible points are blocked critical points. After the image is acquired by the electronic device 120, it is detected whether the constituent elements in the indication signs have any blocking defect. If it is detected that the constituent elements in the indication signs have a blocked area, whether the critical points of the constituent elements are present in the blocked area is further determined. If there are critical points in the blocked area, the locations and the categories of the critical points are determined, wherein the categories are the invisible points. In some examples, the critical points in the blocked area may be determined based on inference. The critical points are falsely marked by this mode, so that the comprehensiveness of the critical points can be ensured, thereby ensuring complete decoding of the semantics of the categories of the critical points.

At step 206, the electronic device 120 determines whether the locations of the critical points satisfy the location condition. The location condition is used for determining whether the critical points belong to the current indication signs.

In some examples, the electronic device 120 analyzes the image to determine the boundary frames of the indication signs and the areas of the boundary frames in the image. Whether the critical points are within the boundary frames is then determined based on the locations of the critical points and the areas of the boundary frames. If the critical points are within the boundary frames, it is determined that the critical points belong to the current indication sign, thereby determining the semantic of the indication sign based on the categories of the critical points. By this mode, each critical point can be ensured to belong to the current indication sign, thereby increasing the accuracy of the critical points.

In some examples, the boundary frames of the indication signs are rotating rectangular frames. By detecting the image, the rotating rectangular frames external to the indication signs in the image are acquired. The parameters of the rotating rectangular frames include at least center point locations, dimension parameters, and angles. Based on the parameters of the rotating rectangular frames, areas of the rotating rectangular frames in the image may be determined. By this mode, the accuracy of the boundary frames may be improved and invalid areas may be reduced as compared to conventional non-rotating rectangular frames, thereby increasing the accuracy of the critical points.

At step 208, if the locations of the critical points satisfy the location condition, the electronic device 120 determines the semantics of the indication signs based on the categories of the critical points. The semantics of the indication signs are the meanings that the indication signs represent. In some examples, when the number of the constituent elements of the indication signs is multiple, the semantics of the indication signs may be determined based on a combination of the categories of the critical points of the plurality of constituent elements. For example, a straight arrow 114 and a right turn arrow 116 are included in the indication signs 112, the critical points of both the straight arrow 114 and the right turn arrow 116 are vertices, the category of the vertex of the straight arrow 114 is the “vertex of the straight arrow”, and the category of the vertex of the right turn arrow 116 is the “vertex of the right turn arrow”. Therefore, it can be determined that the semantics of the indication signs 112 are “straight and right turn signs”.

Alternatively or additionally, when the number of the constituent elements of the indication signs is single, the semantics of the indication signs may be determined directly based on the categories of the critical points of the constituent elements. For example, there is only one straight arrow being present in the indication sign 118, the critical point of the straight arrow is the vertex of the straight arrow, and the category of the vertex of the straight arrow is the “vertex of the straight arrow”. Therefore, it can be determined that the semantic of the indication sign 118 is a “straight sign”.

In examples of the present disclosure, the image collected by a sensing apparatus such as a vehicle-mounted camera and containing indication signs is acquired first, wherein the indication signs may include at least one arrow element, may also include at least one line segment element, or may also include a combination of at least one arrow element and at least one line segment element. The image is then detected, thereby determining a location and a category of a critical point of each constituent element in the indication signs. Further, when the locations of the critical points satisfy a location condition, based on the category of the critical point of each constituent element in the indication signs, semantics of the indication signs are determined (e.g., the semantics of the indication signs may be composition information of the category of the critical point of each constituent element).

By this mode, a location and a category of each critical point of the constituent elements in the indication signs may be calculated directly based on the image. The locations of the critical points can be directly used for identifying areas of the indication signs (the locations of the critical points can be used for identifying areas of the corresponding constituent elements, when the number of the constituent elements is one, the areas of the indication signs can be directly identified based on the locations of the critical points, and when the number of the constituent elements is multiple, the areas of the indication signs can be identified based on a combination of the locations of the critical points), through the locations of the critical points, the areas of the indication signs can be quickly determined, and information redundancy (particularly when the number of constituent elements in the indication signs is large, boundary frames will overlap a lot) caused when the indication signs are identified by a mode of boundary frames and the like can be avoided; and meanwhile, the quantity of parameters in the process of determining the areas of the indication signs can be reduced. The categories of the critical points, as semantic information of the critical points, can increase the richness of information of the critical points, thereby directly determining the semantics of the indication signs based on the categories of the critical points, and avoiding the inaccurate and incomplete results caused by directly classifying the entire indication signs. As a result, the mode of the present disclosure can improve the accuracy and speed of detection of the indication signs and reduce redundant information.

FIG. 3A shows a schematic view of an indication sign 300A including a bottom left corner point according to some examples of the present disclosure. The indication sign 300A includes a straight arrow sign, a left turn arrow sign, a right turn arrow sign, a straight and left turn arrow sign, a straight and right turn arrow sign, a U-turn arrow sign, a straight and U-turn arrow sign, and a left turn and U-turn arrow sign. Referring to FIG. 3A, 302A shows a straight arrow sign including a bottom left corner point, 304A shows a left turn arrow sign including a bottom left corner point, 306A shows a right turn arrow sign including a bottom left corner point, FIG. 308A shows a straight and left turn arrow sign including a bottom left corner point (the bottom left corner point serving as the bottom left corner point of the straight arrow and the left turn arrow at the same time), 310A shows a straight and right turn arrow sign including a bottom left corner point (the bottom left corner point serving as the bottom left corner point of the straight arrow and the right turn arrow at the same time), 312A shows a U-turn arrow sign including a bottom left corner point, 314A shows a straight and U-turn arrow sign including the bottom left corner point (the bottom left corner point serving as the straight arrow and the U-turn arrow at the same time), and 316A shows a left turn and U-turn arrow sign including the bottom left corner point (the bottom left corner point serving as the left turn arrow and the U-turn arrow).

FIG. 3B shows a schematic view of an indication sign 300B including a bottom right corner point according to some examples of the present disclosure. The indication sign 300B includes a straight arrow sign, a left turn arrow sign, a right turn arrow sign, a straight and left turn arrow sign, a straight and right turn arrow sign, a U-turn arrow sign, a straight and U-turn arrow sign, and a left turn and U-turn arrow sign. Referring to FIG. 3B, 302B shows a straight arrow sign including a bottom right corner point, 304B shows a left turn arrow sign including a bottom right corner point, 306B shows a right turn arrow sign including a bottom right corner point, FIG. 308B shows a straight and left turn arrow sign including a bottom right corner point (the bottom right corner point serving as the bottom right corner point of the straight arrow and the left turn arrow at the same time), 310B shows a straight and right turn arrow sign including a bottom right corner point (the bottom right corner point serving as the bottom right corner point of the straight arrow and the right turn arrow at the same time), 312B shows a U-turn arrow sign including a bottom right corner point, 314B shows a straight and U-turn arrow sign including the bottom right corner point (the bottom right corner point serving as the straight arrow and the U-turn arrow at the same time), and 316B shows a left turn and U-turn arrow sign including the bottom right corner point (the bottom right corner point serving as the left turn arrow and the U-turn arrow).

FIG. 3C shows a schematic view of an indication sign 300C including a vertex according to some examples of the present disclosure. The indication sign 300C includes a straight arrow sign, a left turn arrow sign, a right turn arrow sign, a straight and left turn arrow sign, a straight and right turn arrow sign, a U-turn arrow sign, a straight and U-turn arrow sign, and a left turn and U-turn arrow sign. Referring to FIG. 3C, 302C shows a straight arrow sign including a vertex, 304C shows a left turn arrow sign including a vertex, 306C shows a right turn arrow sign including a vertex, 308C shows a straight and left turn arrow sign including a vertex, 310C shows a straight and right turn arrow sign including a vertex, 312C shows a U-turn arrow sign including a vertex, 314C shows a straight and U-turn arrow sign including a vertex, and 316C shows a left turn and U-turn arrow sign including a vertex.

FIG. 3D shows a schematic view of an indication sign 300D including an inflection point according to some examples of the present disclosure. The indication sign 300D includes a U-turn arrow sign, a straight and U-turn arrow sign and a left turn and U-turn arrow sign. FIG. 302D shows a schematic diagram of a U-turn arrow sign including an inflection point, FIG. 304D shows a schematic diagram of a straight and U-turn arrow sign including an inflection point (the inflection point is the inflection point of the U-turn arrow), and FIG. 306D shows a schematic diagram of a left turn and U-turn arrow sign including an inflection point (the inflection point is the inflection point of the U-turn arrow).

FIG. 3E shows a schematic view of an indication sign 300E including a vertex and corner points according to some examples of the present disclosure. The indication sign 300E includes a right merging arrow sign and a left merging arrow sign; with reference to FIG. 3E, 302E shows a right merging arrow sign including a vertex, a bottom left corner point and a bottom right corner point; and 304E shows a left merging arrow sign including a vertex, a bottom left corner point and a bottom right corner point.

FIG. 3F shows a schematic diagram of an indication sign 300F including an endpoint according to some examples of the present disclosure. Referring to FIG. 3F, the indication sign 300F includes a dashed line sign and a prohibition sign. 302F shows one line segment that includes two endpoints in the dashed line sign, and 304F shows a prohibition flag that includes four endpoints.

FIG. 3G shows a schematic view of an indication sign 300G including a plurality of critical points according to some examples of the present disclosure. Referring to FIG. 3G, the indication sign 300G is a straight and left turn arrow sign including two constituent elements of a straight arrow and a left turn arrow. The electronic device 120 detects the image including the indication signs 300G, thereby obtaining 4 critical points, which are the vertex of the straight arrow, the vertex of the left turn arrow, the bottom left corner point of the straight arrow/left turn arrow, and the bottom right corner point of the straight arrow/left turn arrow, respectively. The locations of the above 4 critical points may be used for identifying an area of the indication sign 300G (thereby replacing the boundary frame). The categories of the above four critical points are the “vertex of the straight arrow”, the “vertex of the left turn arrow”, the “bottom left corner point of the straight arrow/left turn arrow”, and the “bottom right corner point of the straight arrow/left turn arrow”, respectively, and through a combination of category information of the critical points, the semantic of the indication sign 300G may be obtained as the “straight and left turn sign”.

FIG. 4 shows a schematic diagram of a process 400 for detecting critical points in indication signs according to some examples of the present disclosure. In some examples, in the example environment 100 shown in FIG. 1, the process 400 may be performed by the electronic device 120. It will be understood that the process 400 may also include additional actions not shown and/or actions that may be omitted as shown, the scope of the present disclosure being not limited in this regard.

In some examples, with reference to FIG. 4, the critical points in the indication signs are detected based on the neural network model. The neural network model includes a backbone network 404, a neck network 406, a head network 410 (may be referred to as a second head network), and a head network 418 (may be referred to as a first head network). The backbone network 404 and the neck network 406 are used for extracting features of the image, the head network 410 is used for predicting parameters of the rotating rectangular frames external to the indication signs, and the head network 418 is used for predicting the locations and the categories of the critical points.

In some examples, the dimension of the image 402 is 600*600*3. The backbone network 404 includes four convolutional layers. After the image 402 passes through the four convolutional layers of the backbone network 404, the dimensions of the resulting image features are 135*240*32, 68*120*64, 34*60*160 and 17*30*384 in sequence. The neck network 406 also includes four convolutional layers. After the 17*30*384 image features output by the backbone network 404 pass through the four convolutional layers of the neck network 406 in sequence, the dimensions of the resulting image features are 17*30*384, 34*60*256, 68*120*128 and 135*240*64 in sequence, wherein the 135*240*64 image feature is a feature map 408.

In some examples, the electronic device 120 acquires the image 402, the image 402 is then input into the backbone network 404 of the neural network model to obtain the encoded image features, and then the image features are input to the neck network 406 for decoding, thereby obtaining the feature map 408. Upon obtaining the feature map 408, the electronic device 120 may process the feature map 408 based on the head network 410, thereby obtaining parameters of the rotating rectangular frames. At the same time, the electronic device 120 may also process the feature map 408 based on the head network 418, thereby obtaining the locations and the categories of the critical points.

In some examples, the electronic device 120 processes the feature map 408 based on the head network 410, thereby obtaining the parameters of the rotating rectangular frames (for determining the areas of the rotating rectangular frames in the image), wherein the parameters of the rotating rectangular frames include the center point locations, the dimension parameters, and the angles. Whether the critical points are within the rotating rectangular frame is determined according to the locations of the critical points and the parameters of the rotating rectangular frames. If the critical points are within the rotating rectangular frames, it is indicated that the critical points belong to the current indication sign. Therefore, the semantics of the indication signs may be determined based on the categories of the critical points.

In some examples, in the process of training the neural network model, an offset amount (which may be referred to as a second offset amount) of the center point locations of the rotating rectangular frames may be determined based on the head network 410 and an offset amount (which may be referred to as a first offset amount) of the critical point locations may be determined based on the head network 418, wherein the offset amount of the center point locations and the offset amount of the critical point locations are used for learning the loss of the image 402 in the coding process. The parameters in the neural network model are then adjusted based on the offset amount of the center point locations and the offset amount of the critical point locations, thereby enabling the offset amount of the center point locations and the offset amount of the critical point locations to satisfy the convergence condition. By this mode, the accuracy of the center point locations and the critical point locations can be improved.

In some examples, the head network 410 includes four branches, the first branch including a convolutional layer 412-1 and a convolutional layer 414-1 which have dimensions of 3*3*64 and 1*1*2, respectively, and the output of the first branch being a center point location 416-1. The second branch includes a convolutional layer 412-2 and a convolutional layer 414-2 which have dimensions of 3*3*64 and 1*1*2, respectively, and the output of the second branch being a wide-height parameter 416-2. The third branch includes a convolutional layer 412-3 and a convolutional layer 414-3 which have dimensions of 3*3*64 and 1*1*2, respectively, and the output of the third branch being an offset amount 416-3 of the center point location. The fourth branch includes a convolutional layer 412-4 and a convolutional layer 414-4 which have dimensions of 3*3*64 and 1*1*2, respectively, and the output of the fourth branch being an angle 416-4 of the rotating rectangular frame.

In the current example, in the process of training the neural network model, a plurality of loss functions may be set up to train the neural network model. In the first branch, the loss of the center point location may be determined based on a Gaussian Focal Loss function. In the second branch, the loss of the width-height parameter may be determined based on an L1 Loss function. In the third branch, the loss of the offset amount of the center point location may be determined based on the L1 Loss function. In the fourth branch, the loss of the angles of the rotating rectangular frames may be determined based on the L1 Loss function. The loss of the neural network model in the training process is determined by the loss function described above, thereby adjusting the parameters in the neural network model to converge the loss.

In some examples, the head network 418 includes two branches. The first branch includes a convolutional layer 420-1 and a convolutional layer 422-1 which have dimensions of 3*3*64 and 1*1*11, respectively, and a result 424-1 is obtained after passing through the two convolutional layers, the result 424-1 including the locations and the categories of the critical points. The electronic device 120 then performs step 426, and the critical points are matched with the rotating rectangular frames, thereby determining whether the critical points are within the areas of the rotating rectangular frames to obtain a matching result 428. If the matching results 428 are within the areas of the rotating rectangular frames, step 430 is performed, the locations and the categories of the critical points are output when the critical points are visible points, and the categories of the critical points are output when the critical points are invisible points. If the matching result 428 is not within the areas of the rotating rectangular frames, step 432 is performed to determine the locations and the categories of the critical points that are not output. The second branch includes a convolutional layer 420-2 and a convolutional layer 422-2 which have dimensions of 3*3*64 and 1*1*2, respectively, the output of the second branch being an offset amount 424-2 of the locations of the critical points.

In the current example, in the process of training the neural network model, a plurality of loss functions may be set up to train the neural network model. In the first branch, the loss of the locations of the critical points may be determined based on the Gaussian Focal Loss function. In the second branch, the loss of the offset amount of the locations of the critical points may be determined based on the L1 Loss function. The loss of the neural network model in the training process is determined by the loss function described above, thereby adjusting the parameters in the neural network model to converge the loss.

Through the mode of the neural network model, the accuracy of the critical points and the rotating rectangular frames can be improved, thereby increasing the accuracy of detection of the indication signs. The neural network model may be trained based on training data for numerous and varied indication signs as compared to the conventional manual feature mode, thereby ensuring the accuracy of prediction of the indication signs and the adaptability to different scenarios, expanding the range of detection of the indication signs, and improving the efficiency of detection of the indication signs. Particularly in scenarios such as parking lots where the indication signs are not standardized, the mode of the present example through the neural network model is very robust.

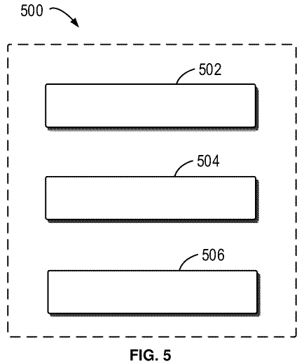

FIG. 5 shows a block diagram of a device 500 for detecting indication signs according to some examples of the present disclosure. With reference to FIG. 5, the device 500 includes an image acquisition module 502 configured to acquire an image including indication signs, constituent elements of the indication signs including at least one of an arrow element and a line segment element. The device 500 further includes a critical point determination module 504 configured to determine, based on the image, locations and categories of critical points of the constituent elements; and in addition, the device 500 further includes an indication sign determination module 506 configured to determine, based on the categories of the critical points, semantics of the indication signs in response to the locations of the critical points satisfying the location condition.

In some examples, the indication sign determination module 506 is further configured to determine, based on the image, areas of boundary frames of the indication signs; determine, based on the locations of the critical points, whether the critical points are within the boundary frame; and determine, based on the categories of the critical points, semantics of the indication signs in response to the critical points within the boundary frame.

In some examples, the boundary frames are rotating rectangular frames, and the indication sign determination module 506 is further configured to: determine, based on the image, parameters of the rotating rectangular frames, the parameters of the rotating rectangular frames including at least center point locations, dimension parameters, and angles; and determine, based on the parameters of the rotating rectangular frames, areas of the rotating rectangular frames.

In some examples, the categories of the critical points include at least one of: a bottom left corner point of a straight arrow, a bottom right corner point of the straight arrow, a vertex of the straight arrow; a bottom left corner point of a turn arrow, a bottom right corner point of the turn arrow, a vertex of the turn arrow; a bottom left corner point of a U-turn arrow, a bottom right corner point of the U-turn arrow, a vertex of the U-turn arrow, an inflection point of the U-turn arrow; and an endpoint of the line segment element.

In some examples, the categories of the critical points further include invisible points, and the critical point determination module 504 is further configured to: determine whether the constituent elements have a blocked area; determine whether critical points are present in the blocked area in response to the presence of the blocked area in the constituent elements; and determine, based on the image, the locations and the categories of the critical points, the categories of the critical points being invisible points.

In some examples, the critical point determination module 504 is configured to: determine, by a backbone network and a neck network of a trained neural network model based on the image, a corresponding feature map; and determine, by a first head network of the neural network model based on the feature map, locations and categories of the critical points.

In some examples, the indication sign determination module 506 is further configured to: determine, by a second head network of the neural network model based on the feature map, parameters of the rotating rectangular frames external to the indication signs, the parameters of the rotating rectangular frames including at least the center point locations, the dimension parameters, and the angles; determine, based on the locations of the critical points and the parameters of the rotating rectangular frames, whether the critical points are within the rotating rectangular frame; and determine, based on the categories of the critical points, the semantics of the indication signs in response to the critical points being within the rotating rectangular frames.

In some examples, a neural network model training module is further included and is configured to: determine, based on the first head network, a first offset amount corresponding to the locations of the critical points; determine, based on the second head network, a second offset amount corresponding to the center point locations; and adjust, based on the first offset amount and the second offset amount, the parameters in the neural network model, such that the first offset amount and the second head network satisfy a convergence condition.

It will be understood that the device 500 of the present disclosure may achieve at least one of a number of advantages that the method or process described above can achieve. For example, the location and the category of each critical point of the constituent elements in the indication signs may be calculated directly by the device 500 based on the image. The locations of the critical points can be directly used for identifying areas of the indication signs (the locations of the critical points can be used for identifying areas of the corresponding constituent elements, when the number of the constituent elements is one, the areas of the indication signs can be directly identified based on the locations of the critical points, and when the number of the constituent elements is multiple, the areas of the indication signs can be identified based on a combination of the locations of the critical points), through the locations of the critical points, the areas of the indication signs can be quickly determined, and information redundancy (particularly when the number of constituent elements in the indication signs is large, boundary frames will overlap a lot) caused when the indication signs are identified by a mode of boundary frames and the like can be avoided; and meanwhile, the quantity of parameters in the process of determining the areas of the indication signs can be reduced. The categories of the critical points, as semantic information of the critical points, can increase the richness of information of the critical points, thereby directly determining the semantics of the indication signs based on the categories of the critical points, and avoiding the inaccurate and incomplete results caused by directly classifying the entire indication signs. As a result, the mode of the present disclosure can improve the accuracy and speed of detection of the indication signs and reduce redundant information.

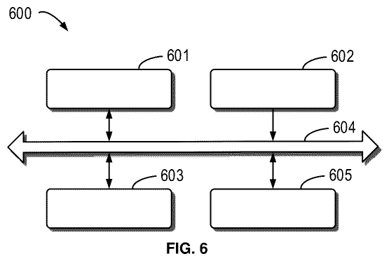

FIG. 6 illustrates a schematic block diagram of an exemplary apparatus 600 that may be used for implementing the examples of the present disclosure. As shown in FIG. 6, the apparatus 600 includes a processor 601, which can perform various appropriate actions and processes according to computer program instructions stored in a read-only memory (ROM) 602 and loaded into a random-access memory (RAM) 603. Various programs and data required for the operation of the apparatus 600 may also be stored in the RAM 603. The processor 601, the ROM 602, and the RAM 603 are interconnected through a bus 604. An input/output (I/O) interface 605 is also connected to the bus 604.

The various processes and processing described above, such as the method 200, may be executed by the processor 601. For example, in some examples, the method 200 can be implemented as a computer software program tangibly contained in a machine-readable medium. In some examples, a part or all of the computer programs may be loaded and/or installed onto the apparatus 600 via the ROM 602. When the computer program is loaded onto the RAM 603 and executed by the processor 601, one or more actions of the method 200 described above may be performed.

The present disclosure may be a method, device, system and/or computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: a random-access memory (RAM), a read only memory (ROM), an erasable programmable read-only memory (EPROM or flash memory), a static random-access memory (SRAM), and any suitable combination of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is able to execute computer-readable program instructions, thereby achieving the various aspects of the present disclosure.

Various aspects of the present disclosure are described herein with reference to flow charts and/or block diagrams depicting methods, apparatus (systems), and computer program products according to the examples of the present disclosure. It should be understood that every block in the flow charts and/or block diagrams and the combinations of various blocks in the flow charts and/or block diagrams may be implemented by computer-readable program instructions.

These computer-readable program instructions may be provided to general-purpose computers, dedicated computers or the processing units of other programmable data processing devices, thereby producing a type of machine, such that when these instructions are executed by the computers or processing units of other programmable data processing devices, an apparatus that realizes the functions/actions stipulated in one or more boxes in the flow charts and/or block diagrams is produced. These computer-readable program instructions may also be stored in computer-readable storage medium, enabling computers, programmable data processing devices, and/or other devices to operate in a specific manner. Therefore, the computer-readable media containing instructions comprise a manufactured product that includes instructions for implementing various aspects of the functions/actions specified in one or more boxes in the flow charts and/or block diagrams.

The computer-readable program instructions may also be loaded onto a computer, other programmable data processing devices, or other devices, enabling a series of operational steps to be executed on the computer, other programmable data processing devices, or other devices to generate a computer-implemented process. This enables the instructions executed on the computer, other programmable data processing devices, or other devices to implement the functions/actions specified in one or more boxes in the flow charts and/or block diagrams.

The flow charts and block diagrams in the accompanying drawings show the system architecture, functions and operations that may be implemented based on the systems, methods and computer program products according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and computer instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used herein aims to best explain the principles and actual applications of various examples as well as the technological improvements in the technology in the market, or allow others of ordinary skill in the art to understand various examples disclosed herein.

What is claimed is:

1. A method for detecting indication signs, comprising:
acquiring an image comprising the indication signs, constituent elements of the indication signs comprising at least one of an arrow element and a line segment element;
determining, based on the image, locations and categories of critical points of the constituent elements; and
determining, based on the categories of the critical points, semantics of the indication signs in response to the locations of the critical points satisfying a location condition.

2. The method according to claim 1, wherein determining, based on the categories of the critical points, the semantics of the indication signs comprises:
determining, based on the image, areas of boundary frames of the indication signs;
determining, based on the locations of the critical points and the areas of the boundary frames, whether the critical points are within the boundary frames; and
determining, based on the categories of the critical points, the semantics of the indication signs in response to the critical points being within the boundary frames.

3. The method according to claim 2, wherein the boundary frames are rotating rectangular frames, and determining, based on the image, the areas of the boundary frames of the indication signs comprises:
determining, based on the image, parameters of the rotating rectangular frames, the parameters of the rotating rectangular frames comprising at least center point locations, dimension parameters, and angles; and
determining, based on the parameters of the rotating rectangular frames, areas of the rotating rectangular frames.

4. The method according to claim 1, wherein the categories of the critical points comprise at least one of:
a bottom left corner point of a straight arrow, a bottom right corner point of the straight arrow, a vertex of the straight arrow;
a bottom left corner point of a turn arrow, a bottom right corner point of the turn arrow, a vertex of the turn arrow;
a bottom left corner point of a U-turn arrow, a bottom right corner point of the U-turn arrow, a vertex of the U-turn arrow, an inflection point of the U-turn arrow; and
an endpoint of the line segment element.

5. The method according to claim 4, wherein the categories of the critical points further comprise invisible points, and determining, based on the image, the locations and the categories of the critical points of the constituent elements comprises:
determining whether the constituent elements have a blocked area;
determining whether the critical points are present in the blocked area in response to the constituent element having the blocked area; and
determining, based on the image, the locations and categories of the critical points in response to the critical points being present in the blocked area, the categories of the critical points being the invisible points.

6. The method according to claim 1, wherein determining, based on the image, the locations and the categories of the critical points of the constituent elements comprises:
determining, by a backbone network and a neck network of a trained neural network model based on the image, a corresponding feature map; and
determining, by a first head network of the neural network model based on the feature map, the locations and the categories of the critical points.

7. The method according to claim 6, wherein determining, based on the categories of the critical points, the semantics of the indication signs comprises:
determining, by a second head network of the neural network model based on the feature map, parameters of rotating rectangular frames external to the indication signs, the parameters of the rotating rectangular frames comprising at least center point locations, dimension parameters, and angles;
determining, based on the locations of the critical points and the parameters of the rotating rectangular frames, whether the critical points are within the rotating rectangular frames; and
determining, based on the categories of the critical points, the semantics of the indication signs in response to the critical points being within the rotating rectangular frame.

8. The method according to claim 7, wherein a training method of the neural network model comprises:
determining, based on the first head network, a first offset amount corresponding to the locations of the critical points;
determining, based on the second head network, a second offset amount corresponding to the center point locations; and
adjusting, based on the first offset amount and the second offset amount, parameters in the neural network model, such that the first offset amount and the second offset amount satisfy a convergence condition.

9. A device for detecting indication signs, comprising:
an image acquisition module configured to acquire an image comprising the indication signs, the constituent elements of the indication signs comprising at least one of an arrow element and a line segment element;
a critical point determination module configured to determine, based on the image, locations and categories of critical points of the constituent elements; and
an indication sign determination module configured to determine, based on the categories of the critical points, semantics of the indication signs in response to the locations of the critical points satisfying a location condition.

10. A controller, comprising:
at least one processor; and
a memory, coupled to the at least one processor, and having instructions stored thereon that, when executed by the at least one processor, cause the controller to perform the method according to claim 1.

11. A vehicle, comprising the controller according to claim 10.

12. A machine-readable storage medium having machine-executable instructions stored thereon, wherein the machine-executable instructions are executed by a processor to implement the method according to claim 1.
